(19) United States
(12) Patent Application Publication
(10) Pub. No.: US 2015/0097371 A1
(43) Pub. Date: Apr. 9, 2015

(54) SYSTEM AND METHOD FOR CONTROLLING ROTATIONAL DYNAMICS OF A POWER GENERATOR

(71) Applicant: General Electric Company, Schenectady, NY (US)

(72) Inventors: Ara Panosyan, Munich (DE); Christoph Boeld, Munich (DE); Herbert Schaumberger, Muenster (AT); Stefan Schroeder, Munich (DE); Lukas Vogl, Innsbruck (AT); Mikhail Avramovich Avanesov, Garching (DE)

(21) Appl. No.: 14/566,145

(22) Filed: Dec. 10, 2014

Related U.S. Application Data
(63) Continuation-in-part of application No. 13/536,245, filed on Jun. 28, 2012.

(51) Int. Cl. H02P 9/00; H02K 49/04

(52) U.S. Cl. CPC H02P 9/006; H02K 49/046
USPC 290/7; 310/93

(57) ABSTRACT

An electromagnetic braking system includes an electrically conductive disc coupled to a rotatable shaft of a power generation system. The rotatable shaft is operatively coupled to a prime mover and a generator. The electromagnetic braking system further includes an inducting unit for applying an electromagnetic braking torque on the electrically conductive disc when commanded by a control signal and a controller for receiving an activation signal from an activating unit, receiving a rotational signal from a rotational sensor coupled to the rotatable shaft or the generator, determining a control signal when the rotational signal is outside of a threshold, and, when the activation signal is active and the rotational signal is outside of the threshold, sending the control signal to the inducting unit to regulate a rotational dynamic of the rotatable shaft.

### CROSS REFERENCE TO RELATED APPLICATIONS

This application is a continuation in part of U.S. patent application Ser. No. 13/536245, entitled “ELECTROMAGNETIC BRAKING SYSTEMS AND METHODS”, filed 28 Jun. 2012, published as US2014-0001756, which is herein incorporated by reference.

### BACKGROUND

The disclosure relates generally to a power generation system and more specifically to systems and methods for controlling rotational dynamics of power generators in the power generation system.

Power generation systems are widely used for generating and distributing power to one or more load devices. Particularly, in grid applications, power generators are typically used to transmit power to a power grid or to an island grid that supports one or more customer loads. Some power generators may be sized in a range from 3 kW to 10000 kW. Traditionally, smaller sized power generators have been diesel generators. However, in recent years, a growth in the use of gas generators for one or more applications has occurred due to tighter emission requirements and improving capabilities of gas engines.

During off-grid operation, a gas engine has generally less transient load acceptance and rejection capability than a diesel engine. Moreover, depending on the type and rating of a gas engine, load rejection may be a challenge. Large load rejections may cause the generators to accelerate and run at over speed, which in turn may lead to tripping the generators. When a fault occurs in the power generation system, voltage in the system may drop by a significant amount, which in turn may cause the generators to accelerate and may go off line in the system.

In aforementioned US2014-0001756, a braking system controller receives one or more status signals from a power generation system and uses the status signals to determine whether and how to initiate braking on a rotatable shaft. It would be desirable to have a braking control system with increased speed and simplicity.

### BRIEF DESCRIPTION

In accordance with one embodiment described herein, an electromagnetic braking system includes an electrically conductive disc coupled to a rotatable shaft of a power generation system, wherein the rotatable shaft is operatively coupled to a prime mover and a generator. Further, the electromagnetic braking system includes an inducting unit for applying an electromagnetic braking torque on the electrically conductive disc when commanded by a control signal. Also, the electromagnetic braking system includes a controller for receiving an activation signal from an activating unit, receiving a rotational signal from a rotational sensor coupled to the rotatable shaft or the generator, determining a control signal when the rotational signal is outside of a threshold, and, when the activation signal is active and the rotational signal is outside of the threshold, sending the control signal to the inducting unit to regulate a rotational dynamic of the rotatable shaft.

In accordance with a further aspect of the present disclosure, a method includes receiving an activation signal from an activating unit coupled to at least one of a generator and a grid, receiving a rotational signal from a rotational sensor coupled to at least one of a rotatable shaft and the generator, determining a control signal based on the activation signal and the rotational signal, and applying an electromagnetic braking torque on the rotatable shaft when commanded by the control signal to regulate a rotational speed of the rotatable shaft.

In accordance with another aspect of the present disclosure, a power generation system includes a prime mover for creating mechanical power and a generator operatively coupled to the prime mover through a rotatable shaft for generating electrical current based on the mechanical power and supplying the electrical current to a grid. Further, the power generation system includes an activating unit operatively coupled to the generator and/or the grid and configured to generate an activation signal. The power generation system additionally includes a rotational sensor operatively coupled to the generator and/or the rotatable shaft and configured to generate a rotational signal and an electromagnetic braking unit operatively coupled to the rotatable shaft for regulating a rotational dynamic of the rotatable shaft based on the activation signal and the rotational signal.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of a power generation system utilizing an electromagnetic braking system and an activating unit, in accordance with aspects of the present disclosure;

FIG. 2 is a flow chart illustrating a method for controlling rotational dynamics in accordance with aspects of the present disclosure; and

FIG. 3 is a diagrammatical representation of a power generation system in accordance with another embodiment of the present disclosure.

### DETAILED DESCRIPTION

Unless defined otherwise, technical and scientific terms used herein have the same meaning as is commonly understood by one of ordinary skill in the art to which this disclosure belongs. The terms “a” and “an” do not denote a limitation of quantity, but rather denote the presence of at least one of the referenced items. The term “or” is meant to be inclusive and mean one, some, or all of the listed items. The use of “including,” “comprising” or “having” and variations thereof herein are meant to encompass the items listed thereafter and equivalents thereof as well as additional items. The terms “connected” and “coupled” are not restricted to physical or mechanical connections or couplings, and can include electrical connections or couplings, whether direct or indirect. Furthermore, the terms “circuit,” “circuitry,” “controller,” and “processor” may include either a single component or a plurality of components, which are either active and/or passive and are connected or otherwise coupled together to provide the described function.

As will be described in detail hereinafter, various embodiments of an exemplary electromagnetic braking system in a power generation system and methods for controlling rotational dynamics of a power generator in the power generation system are presented. By employing the methods and the various embodiments of the electromagnetic braking system described hereinafter, capabilities to ride through load rejections and/or low voltages are provided to the power generation system at a very low cost.

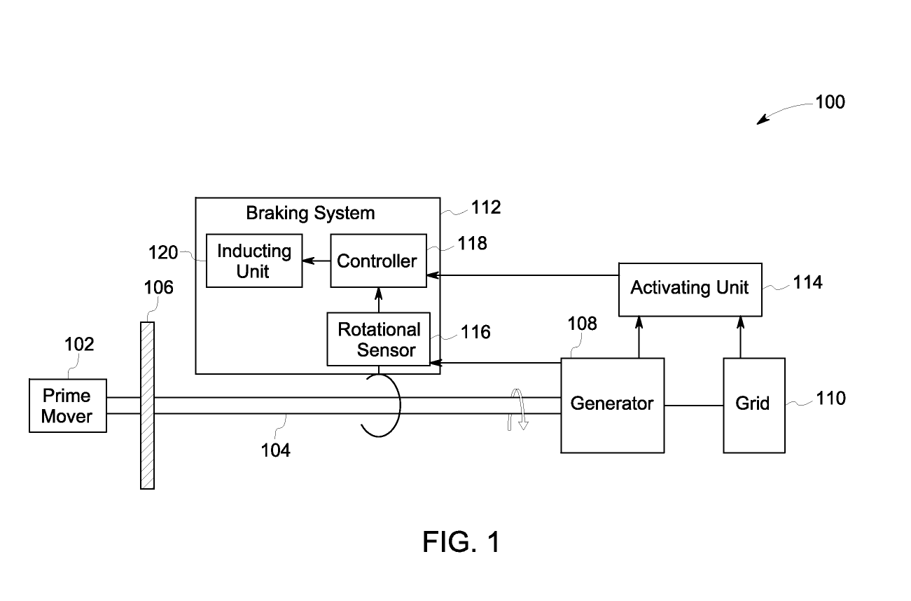

Referring to FIG. 1, a power generation system 100 having an electromagnetic braking unit 112, in accordance with aspects of the present disclosure, is depicted. The power generation system 100 is typically used to convert mechanical power into electrical power. For example, in a gas engine system, fuel energy of gas combusted in a gas engine is converted into mechanical power. Further, this converted mechanical power is in turn used to generate electrical power.

In a presently contemplated configuration, the power generation system 100 includes a prime mover 102, a rotatable shaft 104, an electrically conductive disc 106, a generator 108, and the electromagnetic braking unit 112. The generator 108 provides electrical power to a grid 110. The grid 110 may be a power grid or an island grid. The prime mover 102 is configured to create mechanical power and may comprise a gas engine, a diesel engine, a wind turbine, or a gas turbine, for example. The prime mover 102 typically includes a rotor (not shown) mechanically coupled to the power generator 108 through the rotatable shaft 104. In one embodiment, one or more gear boxes (not shown) may be coupled between the prime mover 102 and the rotatable shaft 104. The rotatable shaft 104 is typically used to convey the mechanical power from the prime mover 102 to the power generator 108. For example, the mechanical power produced at the prime mover 102 may be used directly or through one or more gearboxes to rotate the rotatable shaft 104 at a predetermined speed. This rotation of the rotatable shaft 104 in turn rotates the rotor of the generator 108 to generate electrical power. In one embodiment, the generator 108 may include a three-phase generator.

The generated electrical power at the generator 108 is transferred to the grid 110. The grid 110 collects the power generated from the generator 108 and optionally additional generators (not shown) and transmits the collected power to support one or more customer loads. The grid 110 may operate as a power grid or an island grid. For example, the grid 110 may be used as the power grid to transmit the electrical power to a different location. In another example, the grid 110 may be used as the island grid that locally supports one or more customer loads.

In the exemplary embodiment of FIG. 1, the electrically conductive disc 106 is coupled to a portion of the rotatable shaft 104 situated between the prime mover 102 and the generator 108. However, the rotatable shaft 104 may extend into and in some cases beyond either or both of the prime mover and the generator, and the electrically conductive disc 106 may be coupled at any position along the rotatable shaft 104. The electrically conductive disc 106 may be a small and light disc that has almost no effect or negligible effect on the inertia of the generator 108. It is to be noted that the dimensions of the electrically conductive disc 106 may vary depending on the type of application, and thus, they should not be intended as limited to the exemplary ones. When the electrically conductive disc 106 is rigidly coupled to the rotatable shaft 104, the rotational speed of the rotatable shaft 104 may be controlled by controlling the rotational speed of the electrically conductive disc 106.

During grid operation, large load rejections may occur at the generator, which in turn may cause the generator to accelerate and run at over speed. This over speed of the generator may lead to tripping the generator. Also, when a fault occurs in the power generation system, particularly in a power grid application, voltage in the system may drop by a significant amount, which in turn may cause the generator to accelerate and potentially go off line.

In the embodiment of FIG. 1, the electromagnetic braking unit 112 and an activating unit 114 are employed to help the power generation system 100 to regulate the rotational dynamics of the rotatable shaft 104 and thus of the generator 108. Thus, speed, rotor angle, and/or acceleration of the generator may be controlled within a respective corresponding threshold value.

As depicted in FIG. 1, the electromagnetic braking unit 112 includes a rotational sensor 116, a controller 118, and an inducting unit 120. As described in aforementioned US2014-0001756, in one embodiment, the inducting unit 120 includes a power source, a static switch or converter, and inductors (not shown). The inductors may include one or more electrical windings that are disposed proximate to the electrically conductive disc 106. Also, these windings are coupled to the power source via the static switch or converter to receive alternating current (AC) or direct current (DC) current from the power source. Further, the electrical windings may generate magnetic field based on the AC or DC current received from the power source via the static switch or converter. In one example, the static switch or converter is configured to regulate the AC or DC current that is provided to the inductors based on one or more control signals received from the controller 118.

Furthermore, the rotational sensor 116 is electrically coupled to the rotatable shaft 104 and/or the generator 108 to determine a rotational signal that is representative of rotational dynamics including at least one of speed, rotor angle, and acceleration of the generator 108. The rotational signal is provided to the controller 118.

The controller 118 further receives an activation signal from the activating unit 114. The activating unit 114 is coupled to the grid 110 and/or to the generator 108. The activating unit 114 is configured to determine a load rejection and/or fault event in the grid 110 based on one or more sensed parameters such as voltage, current, power, and load information at the grid 110 and/or the generator 108.

Upon determining the load rejection and/or fault event in the grid 110, the activating unit 114 generates an activation signal. The activation signal is sent to the controller 118. In one example, the activation signal is used to activate the controller 118 by turning ON the control processing features of the controller 118 which then uses the rotational signal to evaluate the rotational dynamics. In another example, the controller 118 is always ON and evaluating rotational dynamics, but the controller 118 does not initiate any braking torque on the rotatable shaft 104 until the controller 118 is activated by the activation signal that is received from the activating unit 114.

After being activated, the controller 118 evaluates the rotational signal to determine whether the rotational signal is outside of a threshold. For example, if the rotational signal includes information regarding the speed, the rotor angle, and the acceleration of the generator 108, then all three values are evaluated to determine whether any is above its respective corresponding threshold value. Or, if only one or two of the speed, the rotor angle, and the acceleration are detected, then only those values are evaluated. If the rotational signal is outside of the threshold, the controller 118 determines a control signal corresponding to an amount of braking torque to be applied on the electrically conductive disc 106 to control the speed, rotor angle, and/or acceleration of the generator 108 to a certain reference value or to keep the speed, rotor angle, and/or acceleration of the generator 108 within threshold values.

The controller 118 then sends the control signal to the inducting unit 120 to apply braking torque on the electrically conductive disc 106 to regulate the rotational dynamics of the rotatable shaft 104. Particularly, the inducting unit 120, upon receiving the control signal, induces a first electromagnetic field on the rotating electrically conductive disc 106. This first electromagnetic field further induces eddy currents in the electrically conductive disc 106. More specifically, the eddy currents are induced in the electrically conductive disc 106 when the electrically conductive disc 106 rotates through the induced first electromagnetic field. These induced eddy currents may further create a second electromagnetic field that is opposing the first electromagnetic field to resist rotation of the electrically conductive disc 106. By controlling the first electromagnetic field induced by the electrical windings on the electrically conductive disc 106, the rotational dynamics of the rotatable shaft 104 are controlled. Also, by controlling the rotational dynamics of the rotatable shaft 104, the rotational dynamics of the generator 108 may be controlled to be at a certain reference value or within threshold values.

After controlling the rotational dynamics of the generator 108 to a certain reference value or within threshold values, the controller 118 may cease the electromagnetic braking torque on the rotatable shaft 104. Particularly, if the controller 118 determines that the rotational dynamics of the generator 108 are such that no braking is needed, braking will cease. However, the controller 118 may remain activated for a certain time after the rotational dynamics of the generator 108 is at a certain reference value or within threshold values, or until the activating unit 114 indicates that the fault event is cleared at the grid 110. In one example, the controller 118 may continuously receive the activation signal from the activating unit 114. If the activation signal includes binary ‘1’ value, the controller 118 determines the presence or existence of the fault event at the grid 110. Similarly, if the activation signal includes binary ‘0’ value, the controller 118 determines the clearance of the fault event at the grid 110. Thus, when the controller 118 receives the activation signal having a ‘0’ value, the controller 118 verifies the rotational dynamics of the generator 108 and, if no braking is needed, the controller 118 may cease the braking immediately or after a certain time.

In addition, in some embodiments, the activating unit 114 may send a deactivation signal to the controller 118 once the fault event has cleared at the grid 110. Further, the controller 118 may cease the braking irrespective of the rotational dynamics of the generator 108, and also the controller 118 may be deactivated. More specifically, the activating unit 114 may verify the clearance of the fault event. If the fault event is cleared, the activating unit 114 may send the deactivation signal to forcefully deactivate the controller 118 and to cease the braking.

In another embodiment, the controller 118 may continuously receive the activation signal during the fault event. Further, when the activation signal is no longer being received, the controller 118 may determine the clearance of the fault event and accordingly may cease the braking.

Thus, by employing the activating unit 114 and the electromagnetic braking unit 112, the fault event and/or the load rejection in the system 100 may be quickly addressed, and accordingly, the generator 108 may be prevented from tripping or going off line in the system 100.

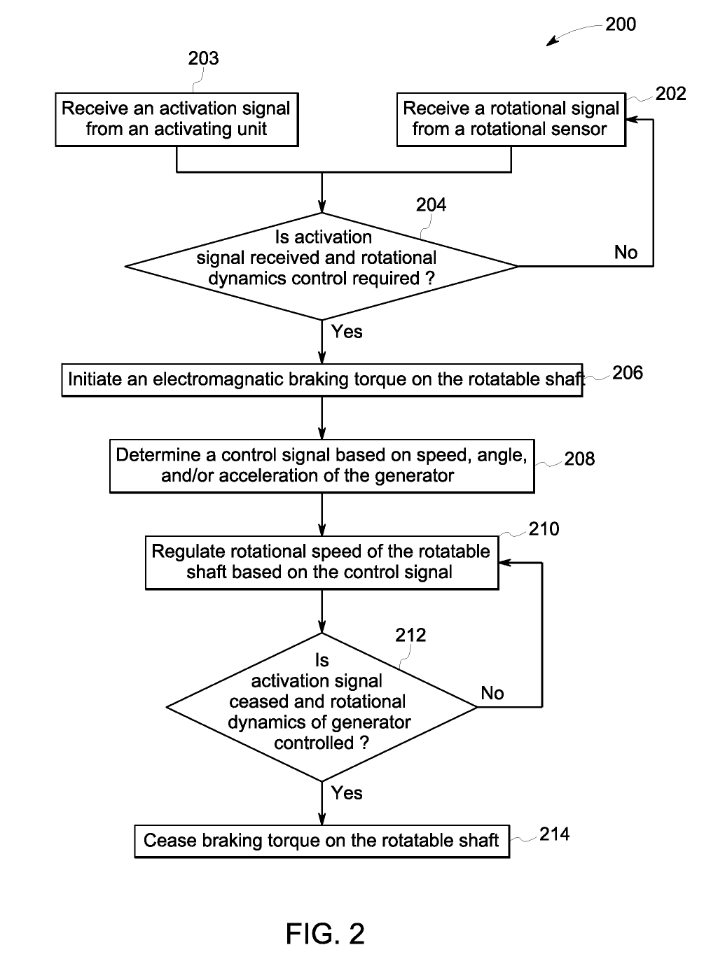

Referring to FIG. 2, a flow chart illustrating a method for controlling rotational dynamics of a generator in a power generation system, in accordance with aspects of the present disclosure, is depicted. For ease of understanding of the present disclosure, the method 200 is described with reference to the components of FIG. 1. The method begins at step 202, where a rotational signal is received from a rotational sensor 116 that is coupled to a rotatable shaft 104 and/or a generator 108. The rotational signal may be representative of one or more rotational dynamics such as speed, rotor angle, and/or acceleration of the generator 108. To that end, the controller 118 receives the rotational signal from the rotational sensor 116. Also, at step 203, the controller 118 receives an activation signal from an activating unit 114. The activation signal may be received if a fault and/or load rejection event occurs at the grid 110.

At step 204, if the activation signal is received and the rotational signal from the rotational sensor 116 is such that rotational dynamics control is needed, the method moves to step 206, where the controller 118 initiates an electromagnetic braking torque on the rotatable shaft 104. Otherwise, the controller 118 is not activated, or it is activated without initiating any braking torque.

At step 208, the control signal is determined based on the speed, the rotor angle, and/or the acceleration of the generator 108. Then, at step 210, an electromagnetic braking torque is applied on the rotatable shaft 204 when commanded by the control signal to regulate the rotational speed of the rotatable shaft 204. Particularly, the inducting unit 120 includes electrical windings that induce first electromagnetic field on the rotating electrically conductive disc 106. This first electromagnetic field further induces eddy currents in the electrically conductive disc 106 when the conductive disc 106 rotates through the induced first electromagnetic field. These induced eddy currents may further create a second electromagnetic field that is opposing the first electromagnetic field to resist rotation of the electrically conductive disc 106. By controlling the first electromagnetic field induced by the electrical windings on the electrically conductive disc 106, the rotational dynamics of the rotatable shaft 104 is controlled. This in turn aids in controlling the speed, the rotor angle, and/or the acceleration of the generator 108 to a certain reference value or within their corresponding threshold values.

Upon regulating the rotational dynamics of the rotatable shaft 104, the method moves to step 212, where the controller 118 verifies whether the speed, the rotor angle, and/or the acceleration of the generator 108 are within their corresponding threshold values and whether the activation signal is ceased or not received from the activating unit 114. If the speed, the rotor angle, and/or the acceleration of the generator 108 are within their corresponding threshold values, then the controller 118 may cease the braking torque on the rotatable shaft 104 at step 214. In one embodiment, the controller 118 may continuously receive the activation signal from the activating unit 114. If the activation signal includes binary ‘1’ value, the controller 118 determines the presence or existence of the fault event at the grid 110. Similarly, if the activation signal includes binary ‘0’ value, the controller 118 determines the clearance of the fault event at the grid 110. Thus, when the controller 118 receives the activation signal having a ‘0’ value, the controller 118 verifies the rotational dynamics of the generator 108 and if no braking is needed, the controller 118 may cease the braking immediately or after a certain time.

In another embodiment, the activating unit 114 may send a deactivation signal to the controller 118 once the fault event has cleared at the grid 110. Further, the controller 118 may cease the braking irrespective of the rotational dynamics of the generator 108, and also the controller 118 may be deactivated. More specifically, the activating unit 114 may verify the clearance of the fault event. If the fault event is cleared, the activating unit 114 may send the deactivation signal to forcefully deactivate the controller 118 and to cease the braking.

Further, moving back to step 212, if the activation signal is not received and/or the rotational dynamics of the generator 108 is not at the reference value or within the threshold values, the method moves to step 210, where the controller 118 continues to regulate the rotational dynamics of the rotatable shaft 104 based on the control signal.

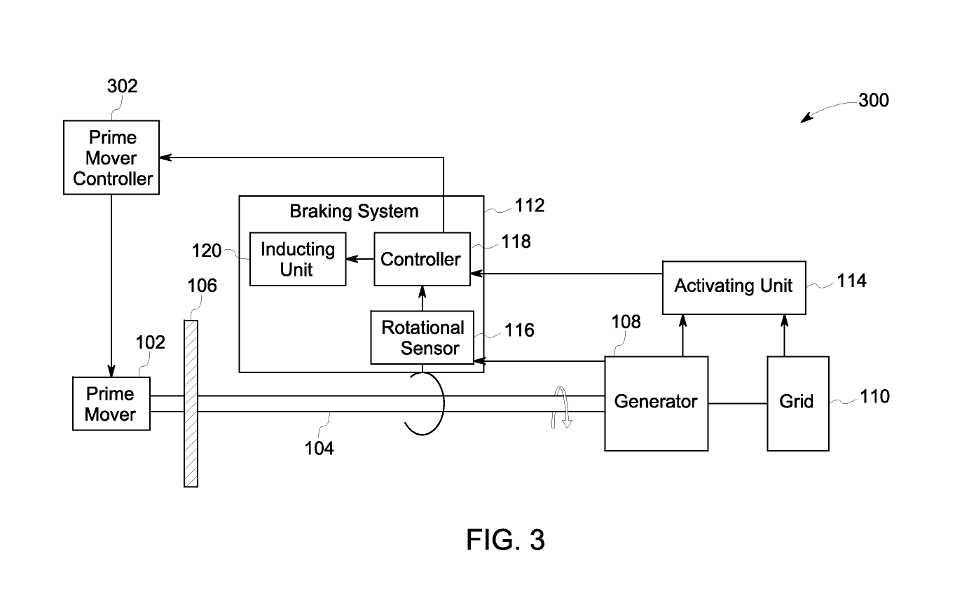

Referring to FIG. 3, a power generation system 300 having an electromagnetic braking unit 112, in accordance with one embodiment of the present disclosure, is depicted. In the embodiment of FIG. 3, a prime mover controller 302 is integrated to the system to control the power provided by the prime mover 102. Particularly, the prime mover controller 302 is coupled to the controller 118 and the prime mover 102, as depicted in FIG. 3. Further, the prime mover controller 302 may receive a continuous signal including braking torque information from the controller 118. In one example, the braking torque information may indicate an amount of the braking torque or power provided to the inducting unit 120. Thereafter, the prime mover controller 302 may send a control signal to the prime mover 102 to control the amount of the power provided to the rotating shaft 104 based on the received braking torque information. In one example, the amount of the power provided by the prime mover may be regulated in coordination with the amount of the braking torque or power provided by the controller 118 to the inducting unit 120.

In one embodiment, if the amount of the braking torque or power is above a reference value, the prime mover controller 302 may send the control signal to the prime mover 102 to regulate the power provided to the rotating shaft 104. The amount of the power provided by the prime mover may be regulated in coordination with the amount of the braking torque or power provided by the controller 118 to the inducting unit 120.

The various embodiments of the system and the method for controlling the speed and rotor angle of the generator aid in riding the load rejections and/or low voltages in the grid. Also, the power electronics employed in the power generation system are very small in terms of power (e.g. less than 5% of braking power) and therewith in terms of size and price. Once an event has been detected, because the electromagnetic braking torque is applied based on a signal, such as the speed, the rotor angle, and/or the acceleration of the generator, system control may be made simpler.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An electromagnetic braking system comprising:
an electrically conductive disc coupled to a rotatable shaft of a power generation system, wherein the rotatable shaft is operatively coupled to a prime mover and a generator;
an inducting unit for applying an electromagnetic braking torque on the electrically conductive disc when commanded by a control signal;
a controller for
receiving an activation signal from an activating unit;
receiving a rotational signal from a rotational sensor coupled to the rotatable shaft or the generator;
determining a control signal when the rotational signal is outside of a threshold;
when the activation signal is active and the rotational signal is outside of the threshold, sending the control signal to the inducting unit to regulate a rotational dynamic of the rotatable shaft.

2. The electromagnetic braking system of claim 1, wherein the activating unit is coupled to at least one of a grid and the generator and configured to generate the activation signal based on a fault event or a load rejection in the grid.

3. The electromagnetic braking system of claim 1, wherein the controller determines the control signal after the activation signal is received from the activating unit.

4. The electromagnetic braking system of claim 1, wherein the rotational signal comprises a speed, a rotor angle, an acceleration, or combinations thereof of the generator or the rotational shaft.

5. The electromagnetic braking system of claim 4, wherein the controller is configured to cease applying braking torque for regulating the rotational dynamic of the rotatable shaft when the activation signal ceases and the rotational signal is at a reference value or within corresponding threshold values.

6. The electromagnetic braking system of claim 5, wherein the controller continues to applying braking torque to regulate the rotational dynamic of the rotatable shaft until the rotational signal is at the reference value or within the corresponding threshold values.

7. A method comprising:
receiving an activation signal from an activating unit coupled to at least one of a generator and a grid;
receiving a rotational signal from a rotational sensor coupled to at least one of a rotatable shaft and the generator;
determining a control signal based on the activation signal and the rotational signal; and
applying an electromagnetic braking torque on the rotatable shaft when commanded by the control signal to regulate a rotational speed of the rotatable shaft.

8. The method of claim 7, further comprising generating the activation signal based on one of a fault event and a load rejection in the grid.

9. The method of claim 7, wherein the rotational signal comprises at least one of speed, rotor angle, and acceleration of the rotatable shaft or the generator.

10. The method of claim 9, further comprising deactivating the controller when the activation signal is ceased and the rotational signal indicates that the speed, the rotor angle and the acceleration of the generator are at a reference value or within corresponding threshold values.

11. The method of claim 10, wherein applying the electromagnetic braking torque comprises regulating the electromagnetic braking torque until the speed, the rotor angle, and the acceleration of the generator are reduced to the reference value or within the corresponding threshold values.

12. A power generation system comprising:
a prime mover for creating mechanical power;
a generator operatively coupled to the prime mover through a rotatable shaft for generating electrical current based on the mechanical power and supplying the electrical current to a grid;
an activating unit operatively coupled to the generator and/or the grid and configured to generate an activation signal;
a rotational sensor operatively coupled to the generator and/or the rotatable shaft and configured to generate a rotational signal; and
an electromagnetic braking unit operatively coupled to the rotatable shaft for regulating a rotational dynamic of the rotatable shaft based on the activation signal and the rotational signal.

13. The power generation system of claim 12, wherein the electromagnetic braking unit comprises:
an electrically conductive disc coupled to the rotatable shaft;
a controller for
receiving the activation signal from the activating unit and the rotational signal from the rotational sensor;
determining a control signal based on the activation signal and the rotational signal; and
an inducting unit for applying an electromagnetic braking torque on the electrically conductive disc when commanded by the control signal to regulate the rotational dynamic of the rotatable shaft.

14. The power generation system of claim 13, wherein the activation signal is generated based on one of a fault event and a load rejection in the grid.

15. The power generation system of claim 13, wherein the rotational signal is generated based on at least one of speed, rotor angle, and acceleration of the generator.

16. The power generation system of claim 13, wherein the controller is configured to cause the control signal to initiate and regulate the electromagnetic braking torque until the activation signal is ceased from the activating unit or the speed, the rotor angle, and the acceleration of the generator is reduced to a reference value or within the corresponding threshold values.

17. The power generation system of claim 12, further comprising a prime mover controller coupled to the controller and the prime mover for regulating power generated by the prime mover.

18. The power generation system of claim 17, wherein the prime mover controller is configured to regulate the power generated by the prime mover in coordination with the electromagnetic braking torque.
